(19) United States
(12) Patent Application Publication
(10) Pub. No.: US 2025/0285824 A1
(43) Pub. Date: Sep. 11, 2025

(54) Tripping Mechanism

(71) Applicant: ABB Schweiz AG, Baden (CH)

(72) Inventors: Jacek Mrowiec, Bielsko-Biala (PL); Adam Skrudlik, Bielsko-Biala (PL); Piotr Honkisz, Kozy (PL); Rafal Mrotek, Bielsko-Biala (PL); Mariusz Olszewski, Bielsko-Biala (PL); Jakub Lugowski, Bielsko-Biala (PL)

(73) Assignee: ABB Schweiz AG, Baden (CH)

(21) Appl. No.: 19/074,018

(22) Filed: Mar. 7, 2025

(30) Foreign Application Priority Data
Mar. 11, 2024 (EP) 24162667

(51) Int. Cl. H01H 71/24; H01H 71/02; H01H 71/52

(52) U.S. Cl. CPC H01H 71/2454; H01H 71/0207; H01H 71/2463; H01H 71/52

(57) ABSTRACT

A tripping mechanism includes a magnetic core with first, second and third yokes, the third yoke comprising a yoke through hole; an armature comprising an armature through hole, a leading rod, a spring and means for tensioning the spring, a tripping lever, means for transferring a movement of the armature, wherein the armature is movably placed between the first yoke and the second yoke, wherein the leading rod extends throughout the magnetic core and the armature and is fixed relative to the magnetic core, wherein the leading rod is placed inside the spring and the spring is placed between the armature and the means for tensioning, wherein the spring is configured to push the armature towards the first yoke.

### CROSS-REFERENCE TO RELATED APPLICATIONS

The instant application claims priority to European Patent Application No. 24162667.0, filed Mar. 11, 2024, which is incorporated herein in its entirety by reference.

### FIELD OF THE DISCLOSURE

The present disclosure generally relates to a tripping mechanism and, more particularly, to an overcurrent tripping unit designed for a high current bus bars.

### BACKGROUND OF THE INVENTION

In the known trip unit design, the tripping force is being transmitted from the armature, located above the breaker busbar, to the space, located below the busbar, by means of the rod (so called “tripping rod”), fixed to the armature assembly and arranged at the side of the trip unit. The tripping rod axis is parallel to the leading rod axis and shifted by certain distance. The tripping rod drives a tripping lever, thus activating the tripping system to open the breaker.

The tripping force produced by the armature assembly, acts along the leading rod axis. The tripping force reaction, coming from the tripping rod, acts along the tripping rod axis. As both axis are shifted by certain distance, the both forces create a momentum. The momentum acts on the armature and then on the leading rod, thus creating additional friction between the armature and the leading rod. Additionally, the momentum creates additional strain in the system, which needs to be compensated by additional armature stroke. Such additional friction and additional stroke have an adverse impact on the breaker high speed opening ability and low current tripping ability.

### BRIEF SUMMARY OF THE INVENTION

A subject of the invention is a tripping mechanism, suitable for use in an overcurrent tripping unit. The tripping mechanism comprising a magnetic core with a first yoke, a second yoke and a third yoke, wherein the third yoke comprising a yoke through hole, an armature comprising an armature through hole, a leading rod with a fixing means, a spring and means for tensioning the spring, a tripping lever, means for transferring a movement of the armature. The armature is movably placed between the first yoke and the second yoke. The leading rod extends throughout the magnetic core, namely between arms of the first yoke, the second yoke, the yoke through hole of the third yoke, and the armature, namely through the armature through hole, while the leading rod position is fixed, in relation to the magnetic core, with the fixing means. The leading rod is placed inside the spring and the spring is placed between the armature and the means for tensioning. The spring extends through the yoke through hole of the third yoke. The spring is configured to force the armature towards the first yoke. The means for transferring a movement of the armature are placed inside the yoke through hole of the third yoke and outside the spring and are configured to transfer a movement of the armature between the first yoke and the second yoke to the tripping lever.

### BRIEF DESCRIPTION OF THE SEVERAL VIEWS OF THE DRAWING(S)

FIG. 1 is an outline view of an overcurrent tripping unit with a tripping mechanism in accordance with the disclosure.

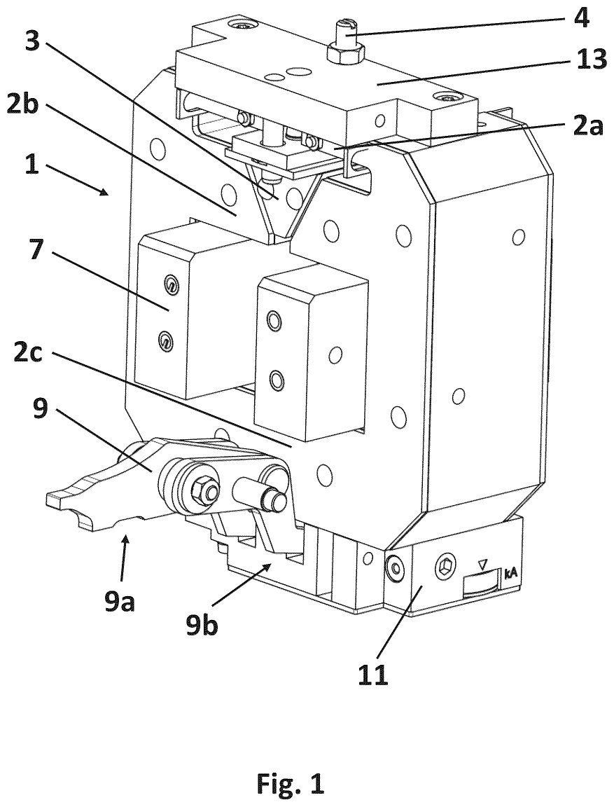

FIG. 2 is a cross section of the overcurrent tripping unit from FIG. 1.

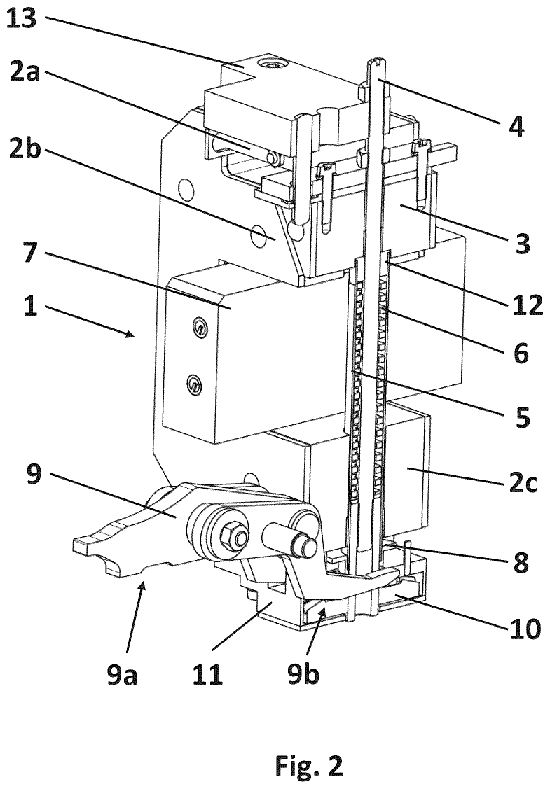

FIG. 3 is a detailed cross section of the tripping mechanism of the overcurrent tripping unit from FIG. 1.

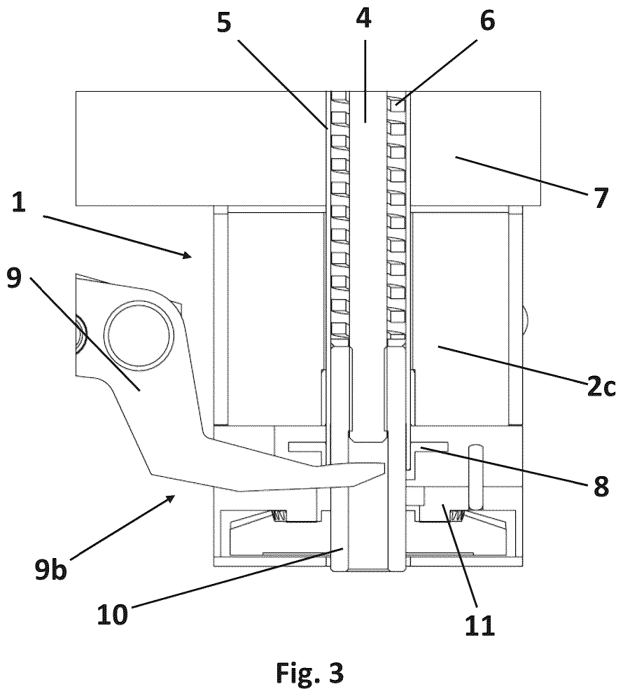

FIG. 4 is a detailed cross section of the tripping mechanism of the overcurrent tripping unit from FIG. 1, wherein the detailed cross section is perpendicular to one showed in FIG. 3.

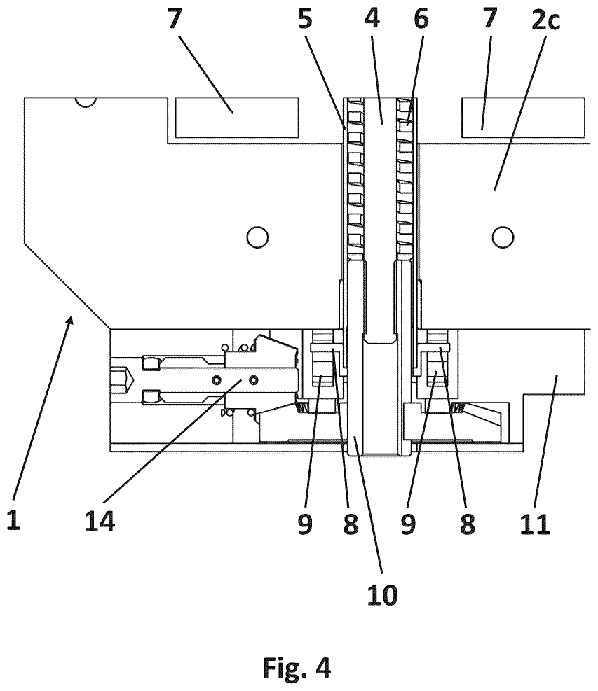

### DETAILED DESCRIPTION OF THE INVENTION

A tripping mechanism, suitable for use in an overcurrent tripping unit is disclosed, which comprises a magnetic core 1, with a first yoke 2a, a second yoke 2b and a third yoke 2c, wherein the third yoke 2c comprising a yoke through hole, an armature 3 comprising an armature through hole, a leading rod 4 with a fixing means, a spring 6 and means for tensioning the spring 6, a tripping lever 9, means for transferring a movement of the armature 3, wherein the armature 3 is movably placed between the first yoke 2a and the second yoke 2b. The leading rod 4 extends throughout the magnetic core 1, namely between arms of the first yoke 2a, the second yoke 2b, the yoke through hole of the third yoke 2c, and the armature 3, namely through the armature through hole, while the leading rod 4 position is fixed, in relation to the magnetic core 1, with the fixing means. The leading rod 4 is placed inside the spring 6 and the spring 6 is placed between the armature 3 and the means for tensioning. The spring 6 extends through the yoke through hole of the third yoke 2c. The spring 6 is configured to force the armature 3 towards the first yoke 2a. The means for transferring a movement of the armature 3 are placed inside the yoke through hole of the third yoke 2c and outside the spring 6 and are configured to transfer a movement of the armature 3 between the first yoke 2a and the second yoke 2b to the tripping lever 9. In such a device a force is generated and transferred with the means for transferring a movement along the axis of the leading rod 4-in such a configuration there is no momentum generated or bending and thus the disadvantages of the tripping mechanism from the prior art has been overcome.

By tensioning it should be understood that the spring 6 is acting such that during normal operation the armature 3 is in a first position, namely near the first yoke 2a and when the current will be greater than the threshold the armature 3 will move toward a second position, namely near the second yoke 2b and then, when the current will stop flowing, the spring 6 will return the armature 3 to the first position. In the shown embodiments the spring 6 is a compression spring, however any other type of a spring which will provide the same result may be used.

In one embodiment the means for transferring a movement of the armature 3 are in form of a tube 5, however the person skilled in the art will know that any other stiff shape may also be used. For example the tube 5 may be perforated or made out of a mesh. In general the means for transferring a movement of the armature 3 do not have to be connected to the armature 3, however such option is possible to implement, for example the tube 5 may be connected to the armature 3. Additionally means for transferring a movement of the armature 3 may also be connected to a guide 12 which is connected to the armature 3, for example the tube 5 may be connected to the guide 12 which is connected to the armature 3. Such connection may be made, for example, either as a tight fit or by means of a thread, however the person skilled in the art will know other possibilities.

In another embodiment the means for transferring a movement of the armature 3 comprises an at least one extending part which is in contact with the tripping lever 9. The at least one extending part provides an easier way to transfer movement from the means for transferring a movement of the armature 3 to the tripping lever 9. For example the at least one extending part is a collar 8. The at least one extending may form a fixed connection with the means for transferring a movement of the armature 3.

In another example the tripping lever 9 comprises a fork which is in contact with the means for transferring a movement of the armature 3.

In another embodiment the tripping lever 9 comprises a straight section 9a and a curved section 9b.

In yet another embodiment one of the fixing means is a regulation tube 10. The regulation tube 10 is configured to acts as the means for tensioning the spring 6, wherein the regulation tube 10 is placed inside a means 11 for positioning the regulation tube 10, which are connected to the magnetic core 1. Other example of the fixing means is a plate 13 fixed to the magnetic core 1, wherein the leading rod 4 is fixed to the plate 13 by means of the screws or thread.

In yet another embodiment a regulation screw 14 is mechanically coupled, preferably with the gearwheels, to the regulation tube 10. The regulation screw 14 allows for an easier regulation especially when the gearwheels provide a ratio where the regulation screw 14 makes more revolution than the regulation tube 10-in such a case a more precise regulation is possible and a stronger spring 6 may be used.

Preferably the means for transferring a movement of the armature are in form of a tube.

Preferably the tube is perforated or made out of a mesh.

Preferably the tube is connected to the armature.

Preferably the tube is connected to a guide which is connected to the armature.

Preferably a connection is made as a tight fit.

Preferably a connection is made by means of a thread.

Preferably the means for transferring a movement of the armature comprises an at least one extending part which is in contact with the tripping lever.

Preferably the at least one extending part is a collar.

Preferably the at least one extending part forms a fixed connection with the means for transferring a movement of the armature.

Preferably the tripping lever comprises a fork which is in contact with the means for transferring a movement of the armature.

Preferably the tripping lever comprises a straight section and a curved section

Preferably one of the fixing means is a regulation tube, wherein the regulation tube is configured to act as the means for tensioning the spring, wherein the regulation tube is placed inside a means for positioning the regulation tube, which are connected to the magnetic core.

Preferably a regulation screw is mechanically coupled, preferably with the gearwheels, to the regulation tube.

Preferably one of the fixing means is a plate fixed to the magnetic core, wherein the leading rod is fixed to the plate by means of the screws or thread.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE NUMBERS

1 Magnetic core
2a First yoke
2b Second yoke
2c Third yoke
3 Armature
4 Leading rod
5 Tube
6 Spring
7 Busbar
8 Collar
9 Tripping lever
9a straight section
9b curved section
10 regulation tube
11 means for positioning the regulation tube
12 guide
13 plate
14 regulation screw

What is claimed is:

1. A tripping mechanism for use in an overcurrent tripping unit, comprising:
a magnetic core having a first yoke, a second yoke and a third yoke, wherein the third yoke comprises a yoke through hole;
an armature comprising an armature through hole;
a leading rod with a fixing device;
a spring and a tensioning device for tensioning a spring;
a tripping lever; and
a transferring structure for transferring a movement of the armature;
wherein the armature is movably placed between the first yoke and the second yoke;
wherein the leading rod extends throughout the magnetic core and between arms of the first yoke, the second yoke, the yoke through hole of the third yoke, and the armature through the armature through hole;
wherein the leading rod position is fixed in relation to the magnetic core with a fixing device;
wherein the leading rod is disposed inside the spring and the spring is disposed between the armature and the tensioning device, wherein the spring extends through the yoke through hole of the third yoke, wherein the spring is configured to force the armature towards the first yoke;
wherein the transferring structure for transferring a movement of the armature is disposed inside the yoke through hole of the third yoke and outside the spring and is configured to transfer a movement of the armature between the first yoke and the second yoke to the tripping lever.

2. The tripping mechanism according to claim 1, wherein the transferring structure is formed as a tube.

3. The tripping mechanism according to claim 2, wherein the tube is perforated or made out of a mesh.

4. The tripping mechanism according to claim 2, wherein the tube is connected to the armature.

5. The tripping mechanism according to claim 2, wherein the tube is connected to a guide which is connected to the armature.

6. The tripping mechanism according to claim 4, wherein a connection is made as a tight fit.

7. The tripping mechanism according to claim 4, wherein a connection is threaded.

8. The tripping mechanism according to claim 1, wherein the transferring structure for transferring a movement of the armature comprises at least one extending part disposed in contact with the tripping lever.

9. The tripping mechanism according to claim 8, wherein the at least one extending part is a collar.

10. The tripping mechanism according to claim 8, wherein the at least one extending part forms a fixed connection with the transferring structure.

11. The tripping mechanism according to claim 1, wherein the tripping lever comprises a fork disposed in contact with the transferring structure.

12. The tripping mechanism according to anyone claim 1, wherein the tripping lever comprises a straight section and a curved section.

13. The tripping mechanism according to claim 1, wherein the fixing device is a regulation tube, wherein the regulation tube is configured for tensioning the spring, wherein the regulation tube is placed inside a positioning structure for positioning the regulation tube, which are connected to the magnetic core.

14. The tripping mechanism according to claim 13, wherein a regulation screw is mechanically coupled with gearwheels to the regulation tube.

15. The tripping mechanism according to claim 1, wherein the fixing device is a plate fixed to the magnetic core, wherein the leading rod is fixed to the plate via threaded connection.
